(19) United States
(12) Patent Application Publication
(10) Pub. No.: US 2012/0290922 A1
(43) Pub. Date: Nov. 15, 2012

(54) Method And Apparatus For Subscribing To Information From A Webpage

(75) Inventor: Gaolin FANG, Shenzhen (CN)

(73) Assignee: TENCENT TECHNOLOGY (SHENZHEN) COMPANY LIMITED, Shenzhen (CN)

(21) Appl. No.: 13/537,748

(22) Filed: Jul. 2, 2012

Related U.S. Application Data
(63) Continuation of application No. PCT/CN2010/080257, filed on Dec. 24, 2010.

(30) Foreign Application Priority Data
Jan. 20, 2010 (CN) 201010003447.6

(51) Int. Cl. G06F 17/00

(52) U.S. Cl. 715/234

(57) ABSTRACT

A method and an apparatus for subscribing to information from a webpage. The method and apparatus make it possible to subscribe to any content block in a webpage and reduce service resource provided by a content provider.

### FIELD OF THE INVENTION

The present invention relates to Internet information processing fields, and more particularly, to a method and an apparatus for subscribing to information from a webpage.

### BACKGROUND OF THE INVENTION

With development of the Internet, most users acquire news information from the Internet. In an original information acquiring method, a user needs to open websites one by one to obtain required information. In order to facilitate the user, it is possible to subscribe to information from the website. When the user browses a webpage, he/she may be interested in only some contents in the webpage. WebSlices provided by IE 8.0 may realize the subscription of some contents in the webpage.

The detailed process for the WebSlices to subscribe to information includes: some special identifiers are added in HTML code of the webpage for identifying a content block in the webpage. Through the special identifiers, the WebSlices is able to realize the subscription of a corresponding block in the webpage.

The inventor of the present invention finds out the following defects of the WebSlices.

Firstly, the WebSlices can only subscribe to contents with the special identifiers. It cannot realize the subscription to any block in the webpage.

Secondly, since it is required to insert the identifiers in the HTML code of the webpage in advance, a content provider of the website needs to provide more service resources.

### SUMMARY OF THE INVENTION

Embodiments of the present invention provide a method and an apparatus for subscribing to information from a webpage, so as to realize a subscription of any content block in the webpage and reduce service resources provided by a content provider or release the content provider from providing service resources related to subscription.

According to an embodiment of the present invention, a method for subscribing to information from a webpage in provided. The method includes:

identifying a webpage block being subscribed to by a user through a first Document Object Model (DOM) tree of a webpage to obtain identification information;

retrieving and storing Universal Resource Locators (URLs) of all links in the webpage block being subscribed to by the user, monitoring the URLs in the webpage block being subscribed to by the user in real-time according to the identification information and the stored URLs to determine whether there is a change in the stored URLs; and

displaying a webpage corresponding to a changed URL if there is a change in the URLs in the webpage block being subscribed to by the user.

According to another embodiment of the present invention, an apparatus for subscribing to information from a webpage is provided. The apparatus includes:

an identification module, adapted to identify a webpage block a user subscribes to by through a first Document Object Model (DOM) tree of a webpage to obtain identification information;

a real-time monitoring module, adapted to retrieve and store Universal Resource Locators (URLs) of all links in the webpage blocks being subscribed to by the user, monitor the URLs in the webpage block being subscribed to by the user according to the identification information and the stored URLs to determine whether there is a change in the URLs; and

a displaying module, adapted to display a webpage corresponding to a changed URL if there is a change in the URLs of the webpage block being subscribed to by the user.

In embodiments of the present invention, the webpage block being subscribed to by the user is identified through the DOM tree of the webpage to obtain the identification information. URLs in the webpage block being subscribed to by the user are retrieved and stored. The URLs in the webpage block being subscribed to by the user are monitored in real time according to the identification information and the stored URLs to determine whether there is a change in the URLs. A webpage corresponding to a changed URL is displayed. Since any content block can be identified automatically in the webpage block, it is not required to identify the content of the webpage by the content provider in advance. Thus, it is possible to subscribe to any content block in the webpage and service resource provided by the content provider is reduced. In addition, a webpage block having been subscribed to by the user can be determined and displayed in the webpage with a particular background color. As such, user's experience is improved.

### BRIEF DESCRIPTION OF THE DRAWINGS

FIG. 1 is a flowchart illustrating a method for subscribing to information from a webpage according to a first embodiment of the present invention.

FIG. 2 is a flowchart illustrating a method for subscribing to information from a webpage according to a second embodiment of the present invention.

FIG. 3 is a schematic diagram illustrating a webpage block according to the second embodiment of the present invention.

FIG. 4 is a schematic diagram illustrating a first DOM tree according to the second embodiment of the present invention.

FIG. 5 is a schematic diagram illustrating a second DOM tree according to the second embodiment of the present invention.

FIG. 6 is a flowchart illustrating a method for subscribing to information from a webpage according to a third embodiment of the present invention.

FIG. 7 is a schematic diagram illustrating a first apparatus for subscribing to information from a webpage according to a fourth embodiment of the present invention.

FIG. 8 is a schematic diagram illustrating a second apparatus for subscribing to information from a webpage according to the fourth embodiment of the present invention.

### DETAILED DESCRIPTION OF THE INVENTION

The present invention will be described hereinafter in further detail with reference to accompanying drawings and embodiments to make the technical solution and merits therein clearer.

### A First Embodiment

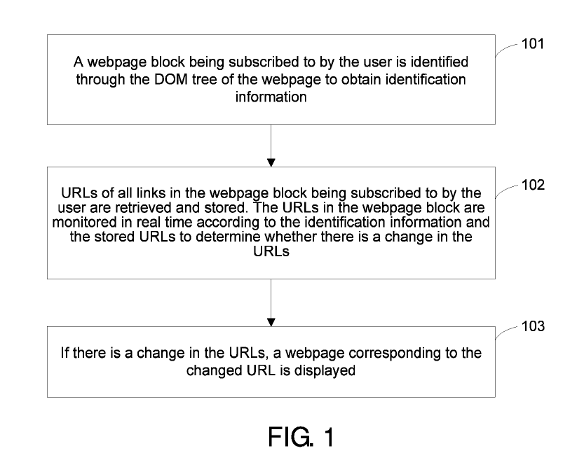

An embodiment of the present invention provides a method for subscribing to information from a webpage. As shown in FIG. 1, the method includes the following steps.

Step 101, when a user subscribes to information in a webpage of a website, a webpage block being subscribed to by the user is identified according to a Document Object Model (DOM) tree of the webpage to obtain identification information.

Step 102, URLs of all links included in the webpage block being subscribed to by the user are retrieved and stored. The URLs in the webpage block being subscribed to by the user are monitored in real time according to the identification information and the stored URLs. If there is a change in the URLs in the webpage block, step 103 is performed.

Step 103, a webpage corresponding to a changed URL is displayed.

In this step, the display of the webpage corresponding to the changed URL includes: the stored URLs are updated according to the changed URL, i.e. the previously stored URLs are replaced by new URLs of all links in the webpage block being subscribed to by the user. The display of the webpage corresponding to the changed URL further includes: text information of the webpage block being subscribed to by the user is displayed to the user, wherein irrelevant information such as advertisement, banner, navigation information and copyright information is eliminated from the text information. In addition, before the text information of the webpage block is displayed to the user, a corresponding webpage in a URL list may be downloaded to analyze in which content that the user is more interested in. Then, the interested content is processed and the text information of the webpage block is displayed to the user.

Since any webpage block in the webpage can be automatically identified, the content provider needs not to identify the content of the webpage in advance. It is possible to subscribe to the content of any block in the webpage and service resource provided by the content provider is reduced.

### A Second Embodiment

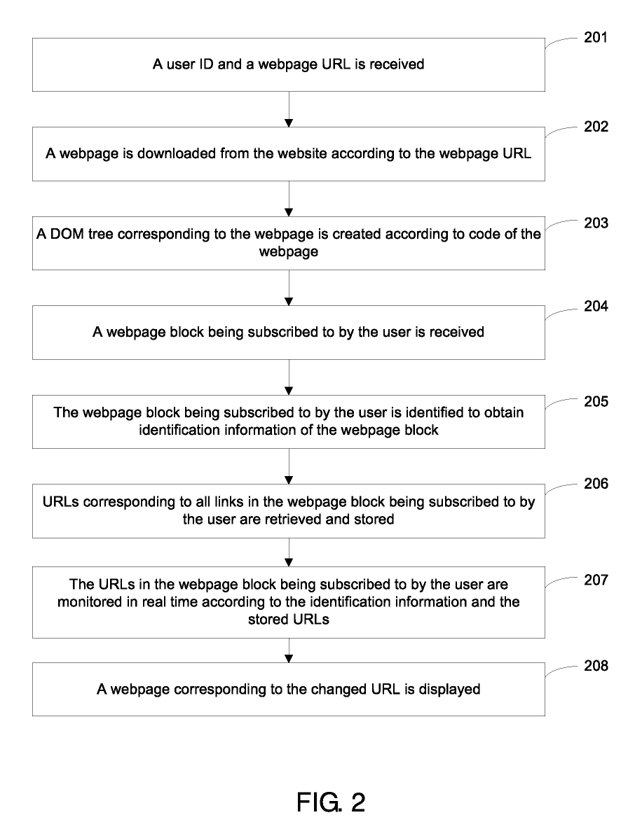

An embodiment of the present invention further provides a method for subscribing to information from a webpage. As shown in FIG. 2, the method includes the following steps.

Step 201, a user ID and a webpage URL are received.

The user needs to subscribe to information from the webpage. The webpage includes at least one webpage block and each webpage block includes at least one basic unit block. Each webpage block has a title and a title URL. Each webpage block includes multiple links and each of them is content carried by the webpage itself.

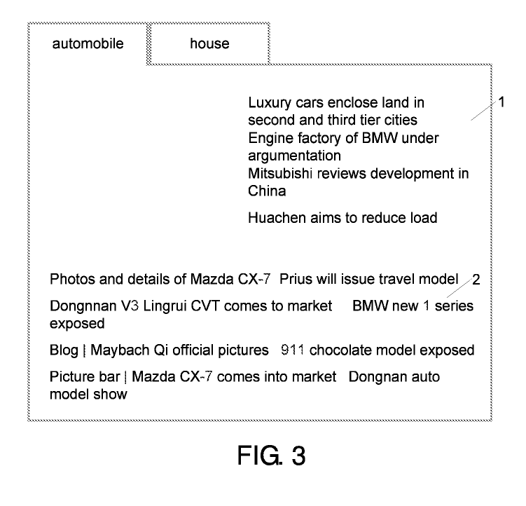

For example, FIG. 3 shows a webpage block entitled “automobile” captured from a homepage of qq.com. The title of the webpage block is “automobile”, and the title URL is “http://auto.qq.com”. The webpage block includes a basic unit block 1, a basic unit block 2 and thirteen links. The links are contents of the homepage of qq.com. In this embodiment, the webpage block is taken as a basic unit for information subscription from the webpage.

In code cited by the webpage, the webpage block is a Div node. Multiple Div nodes are nested in this Div node. The basic unit block is also a Div node. And the Div node corresponding to the basic unit block is nested in the Div node corresponding to the webpage block. No Div node is nested in the Div node corresponding to the basic unit block. And the number of characters included in the basic unit block exceeds a pre-defined threshold. Generally, the threshold is configured to be 20.

Step 202, a corresponding webpage is downloaded from the website according to the webpage URL.

To download the webpage is to download the code cited by the webpage. The code may be HTML or XML code. The downloaded code is saved in a text file. After the code of the webpage is downloaded, an absolute path in the code is changed to a relative path. At the same time, relative path information of Cascading Style Sheets (CSS) and IMG in the webpage is completed. Thus, the webpage can be displayed normally to the user (which is prior art and will not be restricted herein in this embodiment).

Step 203, according to the code of the webpage, a DOM tree corresponding to the webpage is created according to an existing document analyzing technique.

The code saved in the text file is scanned according to document analyzing technique to create the DOM tree corresponding to the webpage. The document analyzing technique takes the webpage block as a node in the DOM tree, takes the title and title URL of the webpage block as sub-nodes of the node corresponding to the webpage block, and takes each basic unit block included in the webpage as a sub-node of the node corresponding to the webpage block. For facilitating the description, the node used for saving the title and the title URL of the webpage block in the DOM tree is referred to as a title node.

Step 204, a webpage block being subscribed to by the user is received.

When the webpage is displayed to the user, the user may select information that the user wants to subscribe to. In this embodiment, since the webpage block is a basic unit for information subscription from the webpage, a webpage block is mapped according to a position of the information that being subscribed to by the user in the webpage and all basic unit blocks included in the webpage block are further obtained. The user may subscribe to one or more webpage blocks. In this embodiment, the situation that the user subscribes to one webpage block is taken as an example. For example, the user wants to subscribe to information in the webpage block shown in FIG. 3 in the homepage of qq.com. According to the position of the information being subscribed to by the user, the webpage block is mapped. The basic unit block 1 and basic unit block 2 included in the webpage block are further obtained. The user ID is ID1 and the URL of the homepage of the qq.com is “http://www.qq.com”.

In addition, in this embodiment, it is also possible to subscribe to information from the webpage in a recommendation manner. Specifically, the title of the webpage block that being subscribed to by the user each time is recorded. When a webpage is displayed to the user, a corresponding webpage block is selected from the webpage according to the recorded title. And the selected webpage block is recommended to the user for acknowledgement. If the user decides to subscribe to the selected webpage block, step 205 is performed. If the user does not want to subscribe to the selected webpage block, the user re-subscribes to required information. For example, the user has subscribed to an “automobile” webpage block. The title “automobile” of the webpage block is recorded. At this time, when the user subscribes to information from the homepage of the qq.com again, the “automobile” webpage block is automatically selected from the homepage of qq.com and is recommended to the user for acknowledgement. If the user decides to subscribe to the “automobile” webpage block, step 205 is performed; otherwise, the user re-subscribes to information from the homepage of qq.com.

Step 205, identification information of the webpage block is obtained through identifying the webpage block. The identification information includes at least a serial number of a first basic unit block of the webpage block, the title and title URL of the title node of the webpage block and the number of basic unit blocks included in the webpage block.

Specifically, the following steps (1) to (4) are included.

(1) the serial number of the first basic unit block of the webpage block and the number of basic unit blocks in the webpage block are obtained.

An initial value for a variable is configured as 0. The DOM tree of the webpage block is traversed according to an existing preorder traverse algorithm. When a node corresponding to a basic unit block is traversed, the value of the variable is added by 1. At the same time, the value of the variable is taken as a serial number of the basic unit block. Then the DOM tree is continued to be traversed. When the traversal of the DOM tree completes, a serial number of the node corresponding to each basic unit block is obtained. It should be noted that, as to the same webpage block, the title node of the webpage block and the node corresponding to each basic unit block in the webpage clock are distributed continuously. Therefore, during the preorder traversal, the title node is firstly traversed. Then the node corresponding to each basic unit block is traversed.

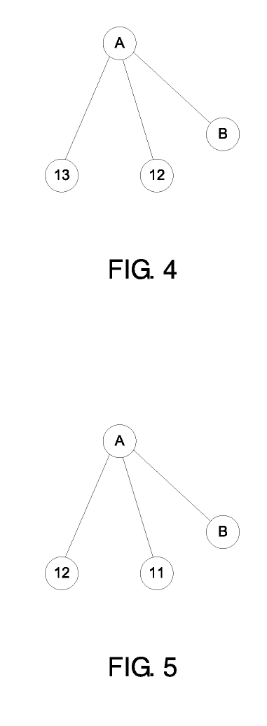

For example, as shown in FIG. 4, the webpage block shown in FIG. 3 is taken as a node A. The title and title URL, basic unit block 1 and basic unit block 2 of the webpage block are taken as three sub-nodes of node A. The three sub-nodes are node B, node 12 and node 13, wherein the node B is the title node. In addition, an initial value of a variable is configured to be 0. The DOM tree is traversed according to the existing preorder traverse algorithm. When the basic unit block 1 and basic unit block 2 in the DOM tree are traversed, suppose that the value of the variable has been added to 11, at this time, the value is further added by 1 to reach 12. And the value 12 is taken as the serial number of the node 12 corresponding to the basic unit block 1. Then, when the node 13 corresponding to the basic unit block 2 is traversed, the value of the variable is added by 1 to reach 13. And the value 13 is taken as the serial number of the node 13 corresponding to the basic unit block 2. The traversal is performed as such until the whole DOM tree is traversed.

That is to say, as to each basic unit block in the webpage block, the DOM tree is firstly traversed, when the node corresponding to the basic unit block is traversed, the number of the node is taken as the serial number of the basic unit block. The basic unit block whose has the minimum sequence number is taken as the first basic unit block. And a minimum serial number is taken as the serial number of the first basic unit block in the webpage block. And the number of basic unit blocks in the webpage block is obtained.

For example, as to the basic unit block 1 and basic unit block 2 in the webpage block shown in FIG. 3, the DOM tree as shown in FIG. 4 is firstly traversed. When node 12 corresponding to the basic unit block 1 is traversed, the number 12 of the node is taken as the serial number of the basic unit block 1. When the node 13 corresponding to the basic unit block 2 is traversed, the number 13 is taken as the serial number of the basic unit block 2. The basic unit block whose has the minimum sequence number is selected as the first basic unit block of the webpage block. The serial number 12 of the basic unit block is taken as the serial number of the first basic unit block of the webpage block. In addition, the number of basic unit blocks in the webpage block is 2.

(2) URL prefixes of all links in the webpage block are read. The number of each kind of URL prefix is calculated. The kind of URL prefix having the maximum number is selected as the URL prefix of the webpage block.

The URLs of multiple links in the webpage block are classified according to their structures. URLs in each category have a common string in their front parts. The common string is the URL prefix of the URL in the category.

The URLs of most or all links of the webpage block have a structure of “URL of the webpage block+sub-table of contents”. The URLs of some links in the webpage block may be in other structures. In the webpage block shown in FIG. 3, the URLs of most links have the structure of “http://auto.qq.com+sub-table of contents”. For example, the URL of a link “luxury cars enclose land in second and third tier cities” is http://auto.qq.com/a/2009 1119/000082.htm. Therefore, as to all URLs whose links having the structure of “URL of the webpage block+sub-table of contents”, the URL prefix retrieved from each URL is the same or similar with the URL of the webpage block. The cases when the URL prefix is similar with the URL of the webpage block include: the URL of the webpage block is a sub-string of the URL prefix, or the URL prefix is a sub-string of the URL of the webpage block. For example, the URL prefix of the link “luxury cars enclose land in second and third tier cities” may be “http://auto.qq.com”. This URL prefix is the same with the URL of the webpage block. For another example, the URL of the link “luxury cars enclose land in second and third tier cities” may also be “http://auto.qq.com/a”. The URL of the webpage block is a sub-string of the URL prefix, i.e. they are similar.

Since the URLs of most or all links in the webpage block have the structure of “URL of the webpage block+sub-table of contents”, the URL prefixes of most or all links are the same or similar with the URL of the webpage block. Therefore, the kind of URL prefix having the largest number is selected as the URL prefix of the webpage block.

(3) According to the selected URL prefix, the title node of the webpage block is searched out from the DOM tree.

Specifically, beginning from the node corresponding to the first basic unit block of the webpage block, the DOM tree is searched forward. When the title node is searched out, it is determined whether the URL in the title node is the same or similar with the URL prefix. If they are the same or similar, the title node is the title node of the webpage block; otherwise, the DOM tree is continued to be traversed.

The forward search is performed in a contrary direction with the preorder traversal of the DOM tree. The backward search has a same direction with the preorder traversal.

For example, suppose the URL prefix of the webpage block shown in FIG. 3 obtained in step (2) is “http://auto.qq.com/a”. From the first basic unit block, i.e. node 12 corresponding to the basic unit block 1, the DOM tree is searched forward. When the title node B is searched out, the URL read from the title node B is “http://auto.qq.com”. Thus, it is determined that the URL is similar with the URL prefix. Therefore, the title node B is the title node of the webpage block shown in FIG. 3.

(4) the URL and title saved in the title node are read to obtain the title and title URL of the title node.

For example, the title and title URL read out from the title node B are “automobile” and “http://auto.qq.com”.

Thus, according to the relationship between the user ID, webpage URL and the identification information, it is possible to save the user ID, the webpage URL and the identification information of the webpage block as a record.

For example, the user ID is ID1, the webpage URL is “http://www.qq.com”, the serial number of the first basic unit block in the webpage block is 12, the title and title URL of the title node of the webpage block are “automobile” and “http://auto.qq.com”, the number of basic unit blocks is 2. The information may be saved as a record and stored as shown in table 1.

TABLE 1

| | | Identification information | | | |
|---|---|---|---|---|---|
| | | Serial number of | | | Number of |
| User | | first basic unit | Title of title | | basic unit |
| ID | URL of webpage | block | node | URL of title node | blocks |
| ID1 | http://www.qq.com | 12 | automobile | http://auto.qq.com | 2 |

| | | |
|---|---|---|
| . . . | . . . | . . . |

Step 206, URLs corresponding to all links in the subscribed webpage block are read and stored, wherein the URLs may be stored in a previously created record according to the user ID and the webpage URL.

In addition, when reading the URLs, a timer may be configured to monitor changes of the URLs in the webpage block. The time of the timer may be configured by the user according to a requirement or may be configured as a default time. The time of the timer is usually configured short, e.g. half an hour or one hour.

For example, thirteen URLs read from the webpage block shown in FIG. 3 are S1, S2, S3, S4, S4, S6, S7, S8, S9, S10, S11, S12 and S13. According to the user ID, i.e. ID1 and the webpage URL “http://www.qq.com”, the thirteen URLs are stored in the record, as shown in table 2. Then, a timer is configured for the record.

TABLE 2

| | | URL included in subscribed |
|---|---|---|
| User ID | URL of webpage | webpage block |
| ID1 | http://www.qq.com | S1, S2, S3, S4, S5, S6, S7, |
| | | S8, S9, S10, S11, S12 and S13 |
| . . . | . . . | . . . |

Step 207, the URLs in the webpage block are monitored according to the identification information obtained and all the stored URLs, if there is a change in the URLs, step 208 is performed.

Specifically, the following steps 1 to 4 are included.

Step 1, when the timer configured in step 206 expires, the identification information is read from the stored record according to the user ID and the webpage URL. The identification information includes at least the serial number of the first basic unit block of the webpage block, the title and title URL of the title node of the webpage block and the number of basic unit blocks in the webpage block.

For example, a timer is configured for the record in step 206. When the timer expires, the identification information is read from the table 1 which includes the relationship between the user ID, webpage URL and the identification information according to the ID1 and “http://www.qq.com” stored in the record. The identification information includes the serial number 12 of the first basic unit block of the webpage block, the title “automobile” and URL “http://auto.qq.com” of the title node and the number 2 of the basic unit blocks in the webpage block.

Step 2, the corresponding webpage is downloaded according to the webpage URL. According to the code cited by the webpage, a DOM tree of the webpage is re-created according to the existing document analyzing technique. The newly-created DOM tree is preorder traversed to obtain the serial number of the node corresponding to each basic unit block in the DOM tree.

The structure of the downloaded webpage may have changed, which makes the structure of the newly-created DOM different from that of the DOM tree created in step 203. Since the time configured for the timer is not long, the structure of the webpage does not change a lot. Therefore, the serial numbers of the nodes corresponding to most basic unit blocks in the DOM tree do not change. Even if the serial numbers of some nodes change, the difference between the old serial number and the new serial number is usually within 3. For example, in this step, the DOM tree of the webpage block with the title “automobile” is as shown in FIG. 5. The title node of the webpage block is node B. The webpage block includes basic unit block 1 and basic unit block 2 which respectively corresponds to node 11 and node 12. The serial numbers of node 11 and node 12 are respectively 11 and 12.

Step 3, according to the identification information read in step 1, the DOM tree is searched for nodes corresponding to all the basic unit blocks of the webpage block and URLs of all links in each node are retrieved, which specifically includes following steps (1) to (5).

(1) according to the serial number of the first basic unit block of the webpage block read in step 1, the node corresponding to the serial number in the newly-created DOM tree is determined as an initial node.

Compared with step 203, the structure of the downloaded webpage in step 207 may have changed. Thus the structure of the DOM tree created in step 207 may also have changed. Therefore, the determined initial node may be the node corresponding to the first basic unit block of the webpage block or not.

For example, according to the serial number 12 of the first basic unit block in the webpage entitled “automobile”, the initial node with serial number 12 is determined in the DOM tree shown in FIG. 5.

(2) the newly-created DOM tree is searched, from the initial node, forward and backward at the same time for the title node. When the title node is searched out, the title and the title URL are read out from the title node.

For example, from the initial node with serial number 12, the DOM tree shown in FIG. 5 is searched forward and backward at the same time for the title node. When the title node B is searched out, the title “automobile” and the title URL “http://auto.qq.com” are read out from the title node B.

(3) it is determined whether the title and the title URL read out are the same as those read out in the identification information in step 1. If they are both the same, the title node is the title node of the webpage block and step (4) is performed, otherwise, step (2) is performed.

For example, it is determined that the “automobile” and “http://auto.qq.com” read out are both the same as the “automobile” and “http://auto.qq.com” stored in the record in step 1, step (4) is performed.

(4) from the title node, the newly-created DOM tree is searched backward continuously for nodes. The number of node to be searched for is the same as the number of basic unit blocks in the webpage block read in step 1.

In the DOM tree, nodes corresponding to basic unit blocks of the same webpage block and the title node of the webpage block are distributed together continuously. Therefore, when the title node of the webpage block is found, the nodes, whose number is the same as the number of the basic unit blocks in the webpage block, from the title node are nodes corresponding to the basic unit blocks of the webpage block.

For example, the number of basic unit blocks in the webpage block entitled “automobile” is 2. From the title node B, the DOM tree shown in FIG. 5 is searched backward continuously for 2 nodes. Node 11 and node 12 are searched out and taken as nodes corresponding to basic unit block 1 and basic unit block 2 of the webpage block respectively.

(5) URLs of all links of all nodes are read out from nodes corresponding to all basic unit blocks of the webpage block, wherein the URLs read out are the URLs of all links included in the webpage block.

For example, the URLs of all links retrieved from node 11 and node 12 include S1, S2, S3, S4, S5, S6, S7, U1, U2, U3, U4, U5 and U6.

Step 4, the URLs of all links included in the webpage block are compared with the URLs of all links stored in the record. If there is a change, step 208 is performed.

Step 208, the webpage corresponding to the changed URL is displayed.

In particular, when there is a change in the URLs of all links included in the webpage block, the URLs of the subscribed webpage block stored in the recorded are updated. And a timer may be re-configured for the record. The configuration is the same as that in step 206. When the timer expires, it is determined whether there is a change in URLs of the subscribed webpage block again according to the above steps.

For example, the read out links S1, S2, S3, S4, S5, S6, S7, U1, U2, U3, U4, U5 and U6 are compared with the stored links S1, S2, S3, S4, S5, S6, S7, S8, S9, S10, S11, S12, S13 in the record. And the stored links S1, S2, S3, S4, S5, S6, S7, S8, S9, S10, S11, S12, S13 in the record are replaced by the read out links S1, S2, S3, S4, S5, S6, S7, U1, U2, U3, U4, U5 and U6, as shown in table 3. A timer is re-configured for the record.

TABLE 3

| | | URL included in subscribed |
|---|---|---|
| User ID | URL of webpage | webpage block |
| ID1 | http://www.qq.com | S1, S2, S3, S4, S5, S6, S7, |
| | | U1, U2, U3, U4, U5 and U6 |
| . . . | . . . | . . . |

Hereinafter, in this embodiment, text information of the subscribed webpage block is displayed to the user in a Really Simple Syndication (RSS) manner. The RSS manner may retrieve text from a Web document of the webpage and display directly.

In this embodiment, the user may subscribe to multiple webpage blocks for one time and obtain identification information of each webpage block. The identification information includes at least the serial number of the first basic unit block of the webpage block, the title and title URL of the title node of the webpage block and the number of basic unit blocks in the webpage block. Then the identification information of each webpage block is stored.

Since any webpage block in the webpage may be automatically identified, it is not required to identify the content of the webpage by the content provider in advance. Therefore, it is possible to subscribe to any content block in the webpage and the service resource provided by the content provider is reduced.

### A Third Embodiment

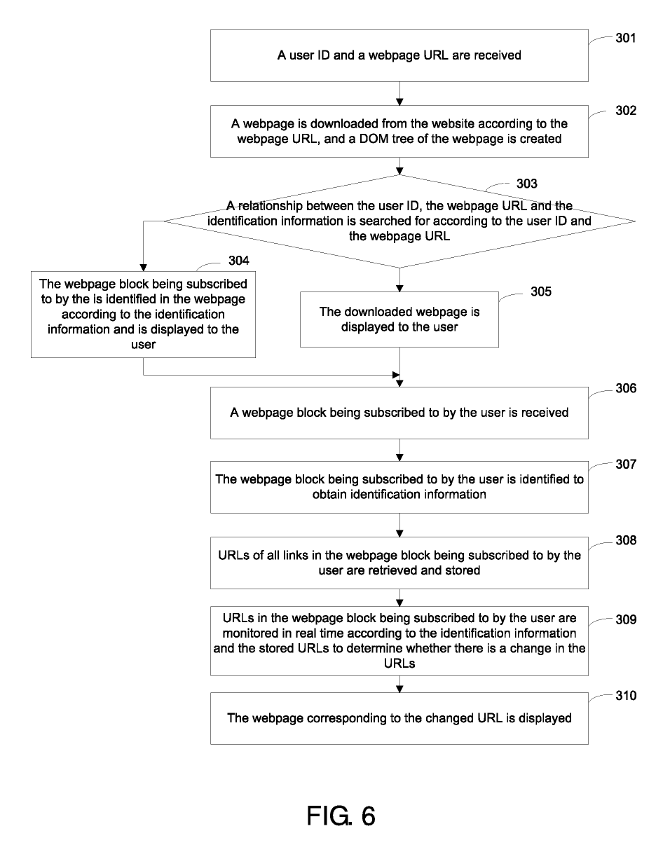

As shown in FIG. 6, another embodiment of the present invention provides a method for subscribing to information from a website. The method includes the following steps.

Step 301, a user ID and a webpage URL are received, wherein the user subscribes to required information from the webpage.

Similarly, in this embodiment, the webpage block may be taken as a unit for information subscription from the webpage.

Step 302, a corresponding webpage is downloaded from the website according to the webpage URL and a DOM tree of the webpage is created according to code cited by the webpage using the document analyzing technique.

Further, the DOM tree is preorder traversed to obtain a serial number of each node in the DOM tree.

Step 303, a corresponding relationship between the user ID, webpage URL and the identification information is searched for according to the user ID and the webpage URL, if the corresponding identification information is found, step 304 is performed; otherwise step 305 is performed.

If a record including the user ID and the webpage URL is found according to the relationship between the user ID, the webpage URL and the identification information, it indicates that the user has subscribed to the webpage block. In this embodiment, it is possible to display the webpage block that the user has subscribed to. The user may modify the subscribed webpage block.

Step 304, the subscribed webpage block is identified in the webpage using a particular background color according to the identification information and is displayed to the user. Then, step 306 is performed.

The identification information includes the serial number of the first basic unit block in the subscribed webpage block, the title and title URL of the title node of the subscribed webpage block and the number of basic unit blocks included in the subscribed webpage block.

In particular, step 1, according to the identification information, the DOM tree is searched for a node corresponding to each basic unit block included in the subscribed webpage block, which specifically includes the following steps.

(1) according to the serial number of the first basic unit block in the subscribed webpage block, a node in the DOM tree is determined as an initial node.

(2) from the initial node, the DOM tree is searched forward and backward at the same time for the title node. When the title node is searched out, the title and title URL are read out from the title node.

(3) it is determined whether the title and title URL read out are the same as those in the identification information. If both of them are the same, the title node is the title node of the webpage block and step (4) is performed; otherwise, step (2) is performed.

(4) from the title node, the DOM tree is searched backward for nodes whose number is the same as the number of basic unit blocks in the subscribed webpage block, i.e. for nodes corresponding to all basic unit blocks in the subscribed webpage block.

Step 2, the node corresponding to each basic unit block in the subscribed webpage block is mapped to a basic unit block in a webpage, and the background color of the mapped basic unit blocks is changed to a particular color. Then, the webpage is displayed to the user.

Each mapped basic unit block is a basic unit block in the subscribed webpage block. After each basic unit block in the subscribed webpage block is displayed in the webpage using the particular background color, the user may modify the subscribed webpage block in the webpage, i.e. re-subscribe to the webpage block.

Step 305, the downloaded webpage is displayed to the user.

The user may select required information to subscribe to from the webpage.

Step 306, a webpage block being subscribed to by the user is received.

Step 307, the identification information of the webpage block is obtained through identifying the webpage block. The identification information includes at least the serial number of the first basic unit block of the webpage block, the title and title URL of webpage block and the number of basic unit blocks included in the webpage block. The ID, the webpage URL and the identification information are taken as a record and stored in the relationship between the user ID, the webpage URL and the identification information.

This step is the same as step 205 in the second embodiment and will not be repeated herein.

Step 308, URLs of all links included in the subscribed webpage block are retrieved and stored. The relationship between the user ID, the webpage URL and the retrieved URLs is stored.

This step is the same as step 206 in the second embodiment and will not be repeated herein.

Step 309, the URLs of the subscribed webpage block are monitored in real time according to the identification information and the stored URLs. If there is a change in the URLs, step 310 will be performed.

This step is the same as step 207 in the second embodiment and will not be repeated herein.

Step 310, the webpage corresponding to the changed URL is displayed.

This step is the same as step 208 in the second embodiment and will not be repeated herein.

Since any webpage block can be automatically identified in the webpage, it is not required to identify the content of the webpage by the content provider in advance. Therefore, it is possible to subscribe to the content of any block in the webpage and the service resource provided by the content provider is reduced. Since the webpage block having been being subscribed to by the user is displayed by a particular background color in the webpage, user's experience is improved.

### A Fourth Embodiment

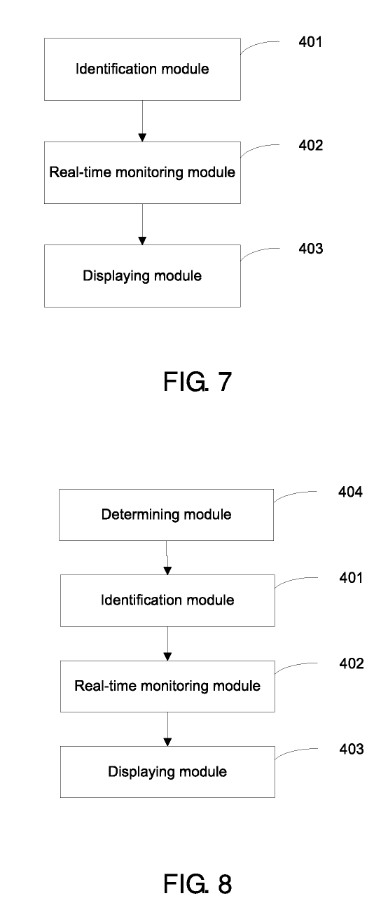

As shown in FIG. 7, an embodiment of the present invention provides an apparatus for subscribing to information from a webpage. The apparatus includes:

an identification module 401, adapted to identify, when a user subscribes to information from a webpage, a webpage block being subscribed to by the user through a DOM tree of the webpage to obtain identification information;

a real-time monitoring module 402, adapted to retrieve and store URLs of all links in the webpage block being subscribed to by the user, monitor the URLs in the webpage block being subscribed to by the user according to the identification information and the stored URLs to determine whether there is a change in the URLs; and

a displaying module 403, adapted to display, when there is a change in the URLs in the webpage block being subscribed to by the user, a webpage corresponding to the changed URL.

The displaying module 403 further includes: an updating sub-module, adapted to update the stored URLs according to the changed URL; a displaying sub-module, adapted to display text information of the webpage block being subscribed to by the user.

The apparatus may further include a pre-creating module, adapted to create the DOM tree of the webpage.

The identification module 401 may include:

a first obtaining unit, adapted to obtain, from the DOM tree of the webpage, a serial number of a first basic unit block of the webpage block being subscribed to by the user and the number of basic unit blocks included in the webpage block being subscribed to by the user;

a second obtaining unit, adapted to obtain a URL prefix of the webpage block being subscribed to by the user; and

a first searching unit, adapted to search, according to the URL prefix, the DOM tree of the webpage block for a title node of the webpage block being subscribed to by the user, and to retrieve a title and a title URL of the title node.

The serial number of the first basic unit block in the webpage block being subscribed to by the user, the number of basic unit blocks in the webpage block being subscribed to by the user, the title and title URL of the title node of the webpage block being subscribed to by the user are taken as identification information.

The first obtaining unit may include:

a traversing sub-unit, adapted to traverse the DOM tree of the webpage block, and to read, when a node corresponding to a basic unit block is traversed, the serial number of the node as the serial number of the basic unit block;

a selecting sub-unit, adapted to select a serial number of a basic unit block who has the minimum sequence number as the serial number of the first basic unit block in the webpage block; and

a first determining sub-unit, adapted to determine the number of basic unit blocks included in the webpage block being subscribed to by the user.

The second obtaining unit may include:

a second determining sub-unit, adapted to retrieve URL prefixes of all links in the webpage block being subscribed to by the user, determine the number of each kind of URL prefix, and select the kind of URL prefix having the maximum number as the URL prefix of the webpage block being subscribed to by the user.

The first searching unit may include:

a first searching sub-unit, adapted to search forward the DOM tree of the webpage from the node corresponding to the first basic unit block for title nodes;

a second-searching sub-unit, adapted to search the title nodes for a title node which has the same or similar URL prefix with the obtained URL prefix as the title node of the webpage block, and retrieve the title and title URL in the title node.

The real-time monitoring module 402 may include:

a reading unit, adapted to read the identification information and the stored URLs;

a creating unit, adapted to create the DOM tree of the webpage;

a determining unit, adapted to determine the initial node in the DOM tree according to the serial number of the first basic unit block in the webpage block being subscribed to by the user;

a second searching unit, adapted to search the DOM tree for nodes corresponding to the basic unit blocks included in the webpage block being subscribed to by the user according to the initial node determined, the title and title URL of the title node and the number of basic unit blocks in the webpage block; and

a comparing unit, adapted to compare the URL in the node corresponding to each basic unit block in the webpage block and the stored URL.

The second searching unit may include:

a third searching sub-unit, adapted to search the DOM tree forward and backward at the same time from the initial node for the title node according to the title and title URL of the title node;

a fourth searching sub-unit, adapted to search the DOM tree continuously from the title node for nodes whose number is equal to the number of basic unit blocks in the webpage block, wherein the node searched for are nodes corresponding to the basic unit blocks in the webpage block.

As shown in FIG. 8, the apparatus may further include:

a determining module 404, adapted to determine whether the webpage includes a webpage block having been subscribed to by the user, and display the webpage block having been subscribed to by the user in the webpage using a particular background color.

In the embodiments of the present invention, any webpage block in the webpage can be automatically identified. Therefore, it is not required to identify the content of the webpage by the content provider in advance. Thus, it is possible to subscribe to the content of any block in the webpage and the service resource provided by the content provider may be reduced.

All or part of the above technical solution provided by the embodiments of the present invention may be implemented by software program stored in a machine readable storage medium, e.g. disk, CD or floppy disk.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method for subscribing to information from a webpage, comprising:
identifying a webpage block being subscribed to by a user through a first Document Object Model (DOM) tree of a webpage to obtain identification information;
retrieving and storing Universal Resource Locators (URLs) of all links in the webpage block being subscribed to by the user, monitoring the URLs in the webpage block being subscribed to by the user in real-time according to the identification information and the stored URLs to determine whether there is a change in the stored URLs; and
displaying a webpage corresponding to a changed URL if there is a change in the URLs in the webpage block being subscribed to by the user.

2. The method of claim 1, wherein the displaying the webpage corresponding to the changed URL comprises:
updating the stored URLs according to the changed URL; and
displaying text information of the webpage block being subscribed to by the user.

3. The method of claim 1, further comprising:
before identifying the webpage block being subscribed to by the user through the first DOM tree of the webpage to obtain the identification information, creating the first DOM tree of the webpage.

4. The method of claim 1, wherein the identifying the webpage block being subscribed to by the user through the first DOM tree of the webpage to obtain the identification information comprises:
obtaining, from the first DOM tree of the webpage, a serial number of a first basic unit block in the webpage block being subscribed to by the user and the number of basic unit blocks included in the webpage block being subscribed to by the user;
obtaining a URL prefix of the webpage block being subscribed to by the user;
searching the first DOM tree of the webpage for a title node of the webpage block being subscribed to by the user according to the URL prefix, retrieving a title and a title URL of the title node;
wherein the identification information comprises: the serial number of the first basic unit block in the webpage block being subscribed to by the user, the number of basic unit blocks included in the webpage block being subscribed to by the user, and the title and the title URL of the title node.

5. The method of claim 4, wherein a node corresponding to the basic unit block does not contain any other node and number of characters included in the basic unit block exceeds a predefined threshold.

6. The method of claim 5, wherein the threshold is 20.

7. The method of claim 4, wherein the obtaining the serial number of the first basic unit block in the webpage block being subscribed to by the user from the first DOM tree of the webpage comprises:
preorder traversing the first DOM tree of the webpage, when a node corresponding to a basic unit block in the webpage block being subscribed to by the user is traversed, reading the serial number of the node as the serial number of the basic unit block;
selecting the serial number of the basic unit block having a minimum sequence number in the webpage block being subscribed to by the user as the serial number of the first basic unit block in the webpage being subscribed to by the user.

8. The method of claim 4, wherein the obtaining the number of basic unit blocks included in the webpage block being subscribed to by the user comprises:
preorder traversing the first DOM tree of the webpage, determining the number of basic unit blocks included in the webpage block being subscribed to by the user.

9. The method of claim 4, wherein the obtaining the URL prefix of the webpage block being subscribed to by the user comprises:
retrieving URL prefixes of all links in the webpage block being subscribed to by the user, determining number of URL prefixes in each kind of URL prefix, selecting the kind of URL prefix having a maximum number as the URL prefix of the webpage block being subscribed to by the user.

10. The method of claim 4, wherein the searching the DOM tree of the webpage for the title node of the webpage block being subscribed to by the user comprises:
searching the first DOM tree of the webpage forward from the node corresponding to the first basic unit block in the webpage block being subscribed to by the user for candidate title nodes;
searching the candidate title nodes for a candidate title node whose URL is the same or similar with the URL prefix, and determining the candidate title node searched out as the title node of the webpage block being subscribed to by the user.

11. The method of claim 4, wherein the monitoring the URLs in the webpage block being subscribed to by the user according to the identification information and the stored URLs to determine whether there is a change in the URLs comprises:
reading the identification information and the stored URLs;
creating a second DOM tree of the webpage;
determining an initial node of the second DOM tree according to the serial number of the first basic unit block in the webpage block being subscribed to by the user;
searching the second DOM tree for nodes corresponding to the basic unit blocks in the webpage block being subscribed to by the user according to the initial node, the title and the title URL of the title node and the number of basic unit blocks in the webpage block being subscribed to by the user;
comparing URLs in the nodes corresponding to the basic unit blocks in the webpage block being subscribed to by the user with the stored URLs.

12. The method of claim 11, wherein the searching the second DOM tree for nodes corresponding to the basic unit blocks in the webpage block being subscribed to by the user according to the initial node, the title and the title URL of the title node and the number of basic unit blocks in the webpage block being subscribed to by the user comprises:
searching the second DOM tree forward and backward at the same time from the initial node for the title node according to the title and the title URL of the title node;
searching the second DOM tree backward from the title node for nodes whose number is the same with the number of basic unit blocks in the webpage block being subscribed to by the user, wherein the nodes to be searched out are nodes corresponding to the basic unit blocks in the webpage block being subscribed to by the user.

13. The method of claim 1, further comprising:
before identifying the webpage block being subscribed to by the user through the first DOM tree of the webpage to obtain the identification information, determining whether there is a webpage block having been subscribed to by the user in the webpage, if there is a webpage block having been subscribed to by the user in the webpage, displaying the webpage block having been subscribed to by the user in the webpage with a particular background color.

14. An apparatus for subscribing to information from a webpage, comprising:
an identification module, adapted to identify a webpage block a user subscribes to by through a first Document Object Model (DOM) tree of a webpage to obtain identification information;
a real-time monitoring module, adapted to retrieve and store Universal Resource Locators (URLs) of all links in the webpage blocks being subscribed to by the user, monitor the URLs in the webpage block being subscribed to by the user according to the identification information and the stored URLs to determine whether there is a change in the URLs; and
a displaying module, adapted to display a webpage corresponding to a changed URL if there is a change in the URLs of the webpage block being subscribed to by the user.

15. The apparatus of claim 14, wherein the displaying model further comprises:
an updating module, adapted to update the stored URLs according to the changed URL; and
a displaying sub-module, adapted to display text information of the webpage block being subscribed to by the user.

16. The apparatus of claim 14, further comprising:
a pre-creating module, adapted to create the first DOM tree of the webpage.

17. The apparatus of claim 14, wherein the identification module comprises:
a first obtaining module, adapted to obtain a serial number of a first basic unit block in the webpage block being subscribed to by the user and the number of basic unit blocks in the webpage block being subscribed to by the user from the first DOM tree of the webpage;
a second obtaining module, adapted to obtain a URL prefix of the webpage block being subscribed to by the user;
a first searching module, adapted to search the first DOM tree of the webpage for a title node of the webpage block being subscribed to by the user according to the URL prefix and retrieve a title and a title URL of the title node;
wherein the identification information comprises the serial number of the first basic unit block in the webpage block being subscribed to by the user, the number of basic unit blocks in the webpage block being subscribed to by the user, and the title and the title URL of the title node.

18. The apparatus of claim 17, wherein the first obtaining module comprises:
a traversing sub-unit, adapted to preorder traverse the first DOM tree of the webpage, when a node corresponding to a basic unit block of the webpage block is traversed, read a serial number of the node as the serial number of the basic unit block;
a selecting sub-unit, adapted to select a serial number of a basic unit block having a minimum sequence number in the webpage block being subscribed to by the user as the serial number of the first basic unit block in the webpage being subscribed to by the user; and
a first determining sub-unit, adapted to determine the number of basic unit blocks in the webpage block being subscribed to by the user.

19. The apparatus of claim 17, wherein the second obtaining unit comprises:
a second determining sub-unit, adapted retrieve URL prefixes of all links in the webpage block being subscribed to by the user, determine the number of each kind of URL prefix, select a kind of URL prefix having a maximum number as the URL prefix of the webpage block being subscribed to by the user.

20. The apparatus of claim 17, wherein the first searching unit comprises:
a first searching sub-unit, adapted to search the first DOM tree of the webpage forward from the node corresponding to the first basic unit block in the webpage block being subscribed to by the user for candidate title nodes;
a second searching sub-unit, adapted to search the candidate title nodes for a candidate title node having a same or similar title URL with the URL prefix as the title node of the webpage block being subscribed to by the user, retrieve the title and the title URL of the title node.

21. The apparatus of claim 14, wherein the real-time monitoring module comprises:
a reading unit, adapted to read the identification information and the stored URLs,
a creating unit, adapted to create a second DOM tree of the webpage;
a determining unit, adapted to determine an initial node in the second DOM tree according to the serial number of the first basic unit block in the webpage block being subscribed to by the user;
a second searching unit, adapted to search the second DOM tree for nodes corresponding to the basic unit blocks in the webpage block being subscribed to by the user according to the initial node, the title and the title URL of the title node and the number of basic unit blocks in the webpage block being subscribed to by the user;
a comparing unit, adapted to compare URLs in the nodes corresponding to the basic unit blocks with the stored URLs.

22. The apparatus of claim 21, wherein the second searching unit comprises:
a third searching sub-unit, adapted to search the second DOM tree forward and backward at the same time from the initial node for the title node according to the title and the title URL of the title node;
a fourth searching sub-unit, adapted to search the second DOM tree backward from the title node for nodes whose number is the same as the number of the basic unit blocks in the webpage block being subscribed to by the user, wherein the nodes to be searched out are nodes corresponding to the basic unit blocks in the webpage block being subscribed to by the user.

23. The apparatus of claim 14, further comprising:
a determining module, adapted to determine whether there is a webpage block having been subscribed to by the user in the webpage, display the webpage block having been subscribed to by the user in the webpage with a particular background color.
